(19) United States
(12) Patent Application Publication
(10) Pub. No.: US 2009/0215928 A1
(43) Pub. Date: Aug. 27, 2009

(54) ETHYLENE/ESTER COPOLYMER NANOFILLER COMPOSITION

(75) Inventors: RICHARD T. CHOU, Hockessin, DE (US); Jingjing Xu, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/332,588

(22) Filed: Dec. 11, 2008

Related U.S. Application Data
(60) Provisional application No. 61/007,865, filed on Dec. 17, 2007.

(51) Int. Cl. C08J 3/22; C08K 3/04; C08K 3/36; C08K 3/34; C08L 31/02

(52) U.S. Cl. 523/351; 524/496; 524/493; 524/445; 524/447; 524/556; 977/742; 977/811

(57) ABSTRACT

A nanofiller masterbatch comprising a nanofiller and an ethylene/ester copolymer having copolymerized units of ethylene and a comonomer selected from monoesters of C₄-C₈ unsaturated acids having at least two carboxylic acid groups, diesters of C₄-C₈ unsaturated acids having at least two carboxylic acid groups, and mixtures of two or more thereof; and a nanocomposite comprising a polyolefin and the nanofiller masterbatch are disclosed. Processes for preparing the nanofiller masterbatch and the nanocomposite are also disclosed.

### PRIORITY CLAIM

This application claims the benefit of U.S. Provisional Application No. 61/007,865, filed Dec. 17, 2007, which is incorporated herein by reference in its entirety.

### FIELD OF THE INVENTION

The present invention relates to ethylene/ester copolymer nanofiller compositions and their use as aids to dispersion of nanofillers in polyolefins.

### BACKGROUND OF THE INVENTION

It is common in the plastics industry to blend various additives with a matrix polymer for the purpose of improving one or more polymer physical properties. In recent years, highly effective nanoparticle fillers have been developed and used as additives in polymer matrices in place of conventional mineral fillers. For example, U.S. Pat. No. 7,270,862 discloses combinations of nanofillers and polyolefins that impart improved barrier properties to polyamide compositions. Such compositions that contain nanofillers dispersed in a polymer matrix are referred to as nanocomposites.

In the field of nanocomposites, the homogeneity of the composite, i.e., the degree of particle dispersion within the polymer matrix, is essential for attaining target performance. Currently, there are three commonly used methods for dispersing nanofillers in polymers. The first is a solvent process which consists of (a) dispersing nanofillers in a selected solvent including water, sometimes with the assistance of a surfactant; (b) dissolving the polymer in the same solvent system; and (c) removing the solvent. This process is generally reserved for basic studies and for high-value, low-volume applications, such as in the medical field, because this method is not easily adapted to industrial use. The second method involves in-situ polymerization and consists of mixing nanofillers with monomers, followed by polymerization. This process is typically used to disperse nanofillers in polymers that can be prepared by condensation polymerization, such as polyamides, polyesters and epoxies. The third method is compounding, a process often carried out by directly melt compounding nanofillers into a polymer melt, such as in an extruder. Of the three methods, compounding is the most practical or preferred for most thermoplastic polymers, especially polyolefins.

Preparation of Polyolefin Nanocomposites Often Requires the Presence of a compatibilizer to achieve good dispersion of the nanofiller within the polymer matrix due to the low polarity of polyolefin resins. For example, maleic anhydride grafted polyolefins have been used to improve the miscibility between polyolefins and clay, such as montmorillonite (see e.g., U.S. Pat. No. 6,632,868). In such cases, the presence of maleic anhydride moieties promotes strong interaction between the polymer matrix and the clay, which leads to enhanced exfoliation and dispersion of the clay platelets. A limitation associated with the use of such compatibilizers is that the amount of maleic anhydride that can be grafted to polyolefins is limited and therefore the effectiveness of the grafted polymers is also limited. Further, as maleic anhydride grafted polyolefins with higher melt flow rate (MFR) (e.g., 50 g/10 min or higher as determined in accordance with ASTM D1238 at 190° C. and 2.16 kg) are difficult to prepare and thus not commercially available, it also limits the formulation optimization for producing nanocomposites. There remains a need for materials which efficiently promote dispersion of nanofillers in quantities that are larger than that which has been possible using prior art methods.

### SUMMARY OF THE INVENTION

The invention is directed to a composition comprising (a) an ethylene/ester copolymer comprising copolymerized units of ethylene and an ester of a C₄-C₈ unsaturated acid, (b) a nanofiller, and optionally (c) a first polyolefin other than an ethylene/ester copolymer comprising copolymerized units of ethylene and an ester of a C₄-C₈ unsaturated acid, wherein (i) the ethylene/ester copolymer is produced by high-pressure random copolymerization and comprises copolymerized units of about 4 to about 20 wt %, based on the total weight of the copolymer, of an ester of a C₄-C₈ unsaturated acid selected from the group consisting of monoesters of C₄-C₈ unsaturated acids having at least two carboxylic acid groups, diesters of C₄-C₈ unsaturated acids having at least two carboxylic acid groups, and mixtures of two or more thereof and (ii) the first polyolefin is selected from the group consisting of ethylene polymers, propylene polymers and blends of two or more thereof. The composition may further comprise (d) a polymer at a level of about 50 to about 90 wt %, based on the total weight of the composition, wherein the polymer may be selected from the group consisting of polyolefins, polyamides, polyesters, polycarbonates, polystyrenes, poly(acrylonitrile-co-butadine-co-styrene) (ABS), and thermoplastic polyurethane.

The invention is further directed to a process for preparing a homogeneous nanofiller masterbatch composition comprising the steps of:
(A) forming a mixture comprising (i) an ethylene/ester copolymer comprising copolymerized units of ethylene and an ester of a C₄-C₈ unsaturated acid, (ii) a nanofiller, and optionally (iii) a first polyolefin other than an ethylene/ester copolymer comprising copolymerized units of ethylene and an ester of a C₄-C₈ unsaturated acid, wherein the ethylene/ester copolymer is produced by high-pressure random copolymerization and comprises copolymerized units of about 4 to about 20 wt %, based on the total weight of the copolymer, of an ester of a C₄-C₈ unsaturated acid selected from the group consisting of monoesters of C₄-C₈ unsaturated acids having at least two carboxylic acid groups, diesters of C₄-C₈ unsaturated acids having at least two carboxylic acid groups, and mixtures of two or more thereof, and wherein the first polyolefin is selected from the group consisting of ethylene polymers, propylene polymers and blends of two or more thereof;
(B) melt compounding the mixture to form the homogeneous nanofiller masterbatch composition; and
(C) recovering the homogeneous nanofiller masterbatch composition.

The invention is yet further directed to a process for preparing a homogeneous nanocomposite composition comprising the steps of:
(A) forming a mixture comprising (i) the nanofiller masterbatch composition obtained by the process recited above and (ii) a polymer selected from a polyamide or a second polyolefin, wherein the second polyolefin is other than an ethylene/ester copolymer comprising copolymerized units of ethylene and an ester of a C₄-C₈ unsaturated acid and is selected from the group consisting of ethylene polymers, propylene polymers and blends thereof;
(B) melt compounding the mixture to form the homogeneous nanocomposite composition; and
(C) recovering the homogeneous nanocomposite composition.

### DETAILED DESCRIPTION OF THE INVENTION

The present invention provides a concentrated nanofiller masterbatch composition comprising (a) an ethylene/ester copolymer obtained from copolymerization of ethylene and an ester comonomer such as a butenedioic monoester or diester, (b) a nanofiller, and optionally (c) a polyolefin that is other than component (a) of the composition of the invention. The masterbatch composition typically comprises about 10 to about 95 wt %, or about 20 to about 90 wt %, or about 30 to about 90 wt %, or about 40 to about 75 wt %, or about 50 to about 60 wt %, of the ethylene/ester copolymer and about 5 to about 70 wt %, or about 10 to about 70 wt %, or about 20 to about 70 wt %, or about 25 to about 60 wt %, or about 30 to about 50 wt %, of the nanofiller, based on the total weight of the masterbatch composition. When component (c) is present, it may be present at a level of up to 80 wt %, or about 10 to about 70 wt %, or a about 20 to about 50 wt %, based on the total weight of the masterbatch composition.

The first component (a) of the masterbatch composition is an ethylene/ester copolymer which may be obtained by copolymerization of ethylene and a comonomer selected from the group consisting of monoesters of C₄-C₈ unsaturated acids having at least two carboxylic acid groups, diesters of C₄-C₈ unsaturated acids having at least two carboxylic acid groups, and mixtures of two or more thereof. That is, the polymer comprises copolymerized units of ethylene and the ester comonomer. Examples of the suitable comonomers include C₁-C₂₀ alkyl monoesters of butenedioc acids (e.g. maleic acid, fumaric acid, itaconic acid and citraconic acid) such as methyl hydrogen maleate, ethyl hydrogen maleate, propyl hydrogen fumarate, and 2-ethylhexyl hydrogen fumarate and C₁-C₂₀ alkyl diesters of butenedioic acids such as dimethylmaleate, diethylmaleate, dibutylcitraconate, dioctylmaleate, and di-2-ethylhexylfumarate. In one embodiment, the ester comonomer is methyl hydrogen maleate or ethyl hydrogen maleate. In a further embodiment, the ester comonomer is ethyl hydrogen maleate.

The ethylene/ester copolymer may be a dipolymer or a higher order copolymer, such as a terpolymer. For example, in forming an ethylene/ester terpolymer, suitable third comonomers may be selected from the group consisting of vinyl acetate, acrylic acid, methacrylic acid, derivatives of acrylic acid and derivatives of methacrylic acid. Suitable derivatives of acrylic acid and methacrylic acid include salts, esters, or other acid derivatives known to one of ordinary skill in the chemical arts. Suitable derivatives of acrylic acid include alkyl acrylates, such as methyl acrylate and butyl acrylate, for example. Suitable derivatives of methacrylic acid include alkyl methacrylates, for example methyl methacrylate and n-butyl methacrylate.

Specific examples of the ethylene/ester copolymers used as the first component of the masterbatch composition include ethylene/maleic acid monoester dipolymers (such as ethylene/ethyl hydrogen maleate dipolymer), ethylene/maleic acid monoester/n-butyl (meth)acrylate terpolymers, ethylene/maleic acid monoester/methyl acrylate terpolymers, ethylene/maleic acid monoester/methyl methacrylate terpolymers, ethylene/maleic acid monoester/ethyl methacrylate terpolymers and ethylene/maleic acid monoester/ethyl acrylate terpolymers.

In one embodiment, the ethylene/ester copolymer comprises about 4 to about 20 wt % copolymerized units of a comonomer or comonomers other than ethylene, based on the weight of the copolymer. In a further embodiment, the level of copolymerized units of the comonomer(s) other than ethylene is in the range of about 4 to about 15 wt %, or about 6 to about 15 wt %, or about 8 to about 15 wt %, or about 8 to about 12.5 wt %, based on the total weight of the copolymer. In addition, when the ethylene/ester copolymer is a terpolymer, copolymerized units of the third comonomer may be present at a level of less than about 10 wt %, or less than about 5 wt %, based on the total weight of the terpolymer.

The ethylene/ester copolymers may be synthesized by random copolymerization of ethylene and the particular comonomer(s) in a high-pressure free radical process, generally an autoclave process. Such processes are described in U.S. Pat. No. 4,351,931. Some examples of this type of ethylene/ester copolymer are described in U.S. Patent Application Publication No. 2005/0187315.

The nanofillers or nanomaterials suitable for use as the second component of the masterbatch composition typically have particle sizes ranging from about 0.9 to about 200 nm, or about 0.9 to about 150 nm, or about 0.9 to about 100 nm, or about 0.9 to about 30 nm. The shape and aspect ratio of the nanofiller may vary. Suitable nanofillers include platy or layered nanofillers. In one embodiment, the nanofillers are selected from nano-sized silicas, nanoclays, and carbon nanofibers. Exemplary nano-sized silicas include, but are not limited to, fumed silica, colloidal silica, fused silica, and silicates. Exemplary nanoclays include, but are not limited to, smectite (e.g., aluminum silicate smectite), hectorite, montmorillonite (e.g., sodium montmorillonite, magnesium montmorillonite, and calcium montmorillonite), bentonite, beidelite, saponite, stevensite, sauconite, nontronite, and illite. The carbon nanofibers used here may be single-walled nanotubes (SWNT) or multi-walled nanotubes (MWNT). Suitable carbon nanofibers are commercially available, such as those produced by Applied Sciences, Inc. (Cedarville, Ohio) under the tradename Pyrograf®,

The nanofillers may be naturally occurring or synthetic materials. In addition, the nanofillers may be surface modified to enhance the hydrophobicity thereof, see, e.g. U.S. Pat. Nos. 6,228,903; 6,225,394; 5,877,248; 5,849,830; 5,844,032; 5,760,121; 5,698,624; 5,578,672; and 5,552,469.

The optional third component (c) of the nanofiller masterbatch composition disclosed herein may be a polyolefin selected from the group consisting of ethylene polymers, propylene polymers and blends thereof. The ethylene polymers include ethylene homopolymers, ethylene copolymers and blends thereof. Similarly, the propylene polymers include propylene homopolymers, propylene copolymers and blends thereof.

The density of suitable polyethylenes may be in the range of about 0.86 to about 0.96 g/cm³, or about 0.87 to about 0.955 g/cm³.

The polyethylenes may be produced by high pressure or low pressure processes. In general, a high pressure process is typically a free radical initiated polymerization conducted at a pressure of about 1000 to about 3000 bar, while a low pressure process is typically conducted at a pressure of less than about 100 bar and with the aid of a catalyst.

Typical catalyst systems for preparing these polyethylenes include magnesium/titanium-based catalyst systems, vanadium-based catalyst systems, chromium-based catalyst systems, metallocene catalyst systems and constrained geometry and other transition metal catalyst systems. Useful catalyst systems include catalysts that comprise chromium or molybdenum oxides on silica-alumina supports.

Specific examples of polyethylenes useful as the optional third component (c) of the masterbatch composition disclosed herein include low density polyethylenes made by high pressure processes, linear low density polyethylenes, very low density polyethylenes, ultra low density polyethylenes, medium density polyethylenes, high density polyethylenes and metallocene catalyzed polyethylenes.

The linear low density polyethylenes may include very low density polyethylenes, ultra low density polyethylenes, and medium density polyethylene types which are also linear, but, generally, have densities in the range of about 0.916 to about 0.925 g/cm³.

The density of the very low density polyethylenes or ultra low density polyethylenes may be in the range of about 0.870 to about 0.915 g/cm³.

Many suitable polyethylenes are available commercially and include, for example, DOWLEX™ polyethylene resins from The Dow Chemical Company, Midland, Mich.

The ethylene copolymers that may be used as the optional third component (c) of the masterbatch composition disclosed here may be copolymers of ethylene and a minor proportion of an α-olefin having 3 to 12 carbon atoms or 3 to 8 carbon atoms. By minor proportion is meant that the weight percentage of copolymerized monomer units of the comonomer other than ethylene that are present in the copolymer chain is less that about 50 wt %, based on the total weight of the copolymer. Examples of suitable α-olefins are propylene, 1-butene, 1-hexene, 4-methyl-1-pentene, and 1-octene. The ethylene copolymer may also be a copolymer of ethylene and an unsaturated acid such as acrylic acid. The ethylene copolymer may also comprise copolymerized units of ethylene and an unsaturated ester other than an ester of a C₄-C₈ unsaturated acid. That is, the ethylene copolymer will be a different copolymer than the ethylene copolymers that constitute component a) of the composition of the invention. The unsaturated esters of the optional ethylene copolymer may be alkyl acrylates, alkyl methacrylates, or vinyl carboxylates. The alkyl groups may have 1 to 8 carbon atoms or 1 to 4 carbon atoms. The carboxylate groups may have 2 to 8 carbon atoms or 2 to 5 carbon atoms. Examples of suitable acrylate and methacrylate comonomers include ethyl acrylate, methyl acrylate, methyl methacrylate, t-butyl acrylate, n-butyl acrylate, n-butyl methacrylate, and 2-ethylhexyl acrylate. Examples of suitable vinyl carboxylates include vinyl acetate, vinyl propionate, and vinyl butanoate. The MFR of the ethylene/unsaturated ester copolymers may be in the range of about 0.5 to about 50 g/10 min or about 2 to about 25 g/10 min.; as determined according to ASTM D1238 (190° C., 2.16 kg).

The ethylene copolymers may be dipolymers or higher order copolymers, for example terpolymers. Alpha-olefins and dienes such as ethylidene norbornene, butadiene, 1,4-hexadiene, or dicyclopentadiene are useful as the additional comonomer(s) in formation of the higher order ethylene copolymers.

The ethylene copolymers may also be ethylene/propylene copolymers, such as EPDM elastomers. Such EPDM polymers are often tetrapolymers, for example copolymers of ethylene, propylene and two diene monomers, wherein the total weight percentage of the diene comonomers may be about 1 to about 15 wt %, or about 1 to about 10 wt %, based on the total weight of the polymer.

Any polypropylene is suitable for use as the optional third component (c) that may be present in the masterbatch composition disclosed here. Examples include homopolymers of propylene, copolymers of propylene and other olefins, and terpolymers of propylene, ethylene, and dienes (for example, norbornadiene and decadiene). Examples of suitable polypropylenes are described in Polypropylene Handbook: Polymerization, Characterization, Properties, Processing, Applications 3-14, 113-176 (E. Moore, Jr. ed., 1996).

Further provided herein is a nanocomposite composition, which, in addition to the nanofiller masterbatch composition disclosed above, further comprises a fourth component (d) polymer. The fourth component (d) of the nanocomposite composition may be any suitable thermoplastic or crosslinked polymer material, such as polyolefins, polyamides, polyesters (e.g., polyethylene terephthalate and polybutylene terephthalate), polycarbonates, polystyrenes, poly(acrylonitrile-co-butadine-co-styrene) (ABS), and thermoplastic polyurethane. In one embodiment, the fourth component (d) of the nanocomposite composition is a polyolefin, such as those described above and useful as the optional third component (c) of the nanofiller masterbatch composition. In those embodiments, where the optional third component (c) is present in the nanofiller masterbatch composition, the polyolefin used as the fourth component (d) of the nanocomposite composition may be the same or different from the polyolefin used as the optional third component (c) of the nanofiller masterbatch. The fourth component (d) may be present in the nanocomposite composition at a level of up to about 95 wt %, or about 50 to about 90 wt %, or about 70 to about 90 wt %, or about 80 to about 90 wt %, based on the total weight of the nanocomposite composition.

The masterbatch and nanocomposite compositions of the invention may further comprise other additives, such as flame-retardant additives (e.g., metal hydroxides, halogenated compounds, and aluminum trihydrate), antioxidants, stabilizers, blowing agents, carbon black, pigments, processing aids, peroxides, and cure boosters. Furthermore, the nanocomposite compositions may be thermoplastics or crosslinked polymers.

The masterbatch and the nanocomposite compositions of the invention may be prepared using a melt process, which includes combining all the components of the composition and melt compounding the mixture at a temperature of about 130° C. to about 230° C., or about 170° C. to about 210° C. to form a uniform, homogeneous blend. The process may be carried out using stirrers, Banbury® type mixers, Brabender® type mixers, or extruders.

For example, a nanocomposite of the invention may be prepared using a melt compounding process that employs a masterbatch of the invention in a first step wherein the components are combined. That is, the first step is carried out by forming a mixture from a masterbatch of the invention and a polyolefin or a polyamide in an extruder or other piece of mixing equipment. Alternatively, a nanocomposite of the invention may be formed in a process which does not employ a masterbatch. Instead, the formation of the mixture involves combining, as separate ingredients, nanofiller, the ethylene/ester copolymer that comprises copolymerized units of ethylene and an ester of a C₄-C₈ unsaturated acid and a polyolefin or polyamide. When polyolefin is used, it may be a material other than a copolymer of ethylene and an ester of a C₄-C₈ unsaturated acid. In either process, the step or steps wherein the mixture is formed may be conducted within or external to the piece of equipment in which melt compounding occurs. In addition, the step wherein the mixture is formed may be conducted at ambient temperature or at temperatures suitable for melt compounding. Methods of recovery of the homogeneous nanocomposite produced by melt compounding will depend on the particular piece of melt compounding apparatus utilized and may be determined by those skilled in the art. For example, if the melt compounding step takes place in an extruder, the homogeneous nanocomposite will be recovered after it exits the extruder die.

In the past, maleic anhydride grafted polyolefins have been used as compatibilizers to aid the dispersion of nanofillers in polyolefins (see e.g., U.S. Patent Application Publication No. 2006/269771). However, the amount of maleic anhydride that can be grafted to polyolefins is limited to only a few weight percent or less than 2 wt %. The random copolymerization process used to prepare the ethylene/ester copolymers that are components of the compositions of the invention permits synthesis of ethylene/ester copolymers having a higher degree of freedom in attaining higher levels of the unsaturated ester comonomer and lower molecular weight (relating to high melt flow index) than the maleic anhydride grafted polyolefins and therefore affords the ethylene/ester copolymers a higher degree of nanofiller dispersing power and activity than the more readily available grafted polyolefins. Moreover, the ethylene/ester copolymers tend to have a wide range of melt flow. For example, an ethylene/ester copolymer having a MFR of up to about 500 g/10 min. (as determined according to ASTM D1238, 190° C., 2.16 kg) can be prepared by synthesizing an ethylene/ester copolymer having a high content of copolymerized unsaturated ester comonomer units. Because of the low viscosity, as indicated by high MFR of the ethylene/ester copolymers, the dispersion of a large quantity of nanofillers in the ethylene/ester copolymer is possible while still maintaining adequate viscosity of the nanofiller masterbatch for processing. Furthermore, due to the high affinity of ethylene/ester copolymers for both nanofillers and polyolefin polymers, a very uniform, homogeneous dispersion of nanofillers in the polyolefin polymer matrix is produced.

Dispersion can be indicated by X-ray diffraction. For example X-ray diffraction (XRD) is commonly used to determine the interlayer spacing (d-spacing) of silicate layers in silicate-containing nanocomposites. When X-rays are scattered from the silicate platelets, peaks of the scattered intensity are observed corresponding to the clay structure. Based on Bragg's law, the interlayer spacing, i.e. the distance between two adjacent clay platelets, can be determined from the peak position of the XRD pattern. When interaction of nanoclay and polymer matrix occurs, the interlayer spacing increases, and the reflection peak of the XRD pattern moves to a lower 2-THETA position. Under such conditions, the nanoclay is considered to be intercalated, an indication of improved dispersion. In general, because nanoclays are not thermally stable the clay particles may collapse at melt processing conditions resulting in poor dispersion. Therefore, effective compatibilizers are often needed when nanocomposites are prepared.

The compositions of the invention, especially the nanocomposite compositions or the nanofiller masterbatch composition that also comprise a polyolefin other than the ethylene/ester component as a third component (c), may be furthered formed into sheets, films, panels, or other shaped articles by conventional processes. These articles have useful properties and a broad range of applications. For example, the sheets or panels comprising such nanocomposites may be used as coating materials for, e.g., wood, glass, ceramic, fabrics, metal, or other plastics. In one embodiment, such compositions can be used to form a coating for a wire or cable. The sheets, films, and panels can also be laminated to other plastic films, sheets or panels.

### EXAMPLES

### Materials

The following materials were used in the examples:
EVA-1—an ethylene/vinyl acetate copolymer comprising 25 wt % copolymerized units of vinyl acetate, based on the total weight of the copolymer, and having a melt flow rate (MFR) of 2 g/10 min, as determined in accordance with ASTM D1238 at 190° C. and 2.16 kg;
EVA-2—an ethylene/vinyl acetate copolymer comprising 28 wt % copolymerized units of vinyl acetate, based on the total weight of the copolymer, and having a MFR of 3 g/10 min (at 190° C. and 2.16 kg)
EVA-3—an ethylene/vinyl acetate copolymer comprising 28 wt % copolymerized units of vinyl acetate and 1 wt % copolymerized units of methacrylic acid, based on the total weight of the copolymer, and having a MFR of 6 g/10 min (at 190° C. and 2.16 kg);
MAH-g-PE—a maleic anhydride grafted linear low density polyethylene (LLDPE) having a density of 0.93 g/cc and a MFR of 1.5 g/10 min (at 190° C., 2.16 kg), available from E. I. du Pont de Nemours and Company (DuPont), Wilmington, Del., under the tradename Fusabond® 226;
E/MAME-1—an ethylene/monoethyl maleate copolymer comprising 9.5 wt % copolymerized units of the monoethyl ester of maleic acid, based on the total weight of the copolymer, and having a MFR of 30 g/10 min (at 190° C., 2.16 kg);
E/MAME-2—an ethylene/monoethyl maleate copolymer comprising 15 wt % copolymerized units of the monoethyl ester of maleic acid, based on the total weight of the copolymer, and having a melt flow rate of 200 g/10 min (at 190° C., 2.16 kg);
E/MAME-3—an ethylene/monoethyl maleate copolymer comprising 6 wt % of copolymerized units of the monoethyl ester of maleic acid, based on the total weight of the copolymer, and having a melt flow rate of 5 g/10 min (at 190° C., 2.16 kg);
E/MAME-4—an ethylene/monoethyl maleate copolymer comprising 10 wt % of copolymerized units of the monoethyl ester of maleic acid, based on the total weight of the copolymer, and having a melt flow rate of 10 g/10 min (at 190° C., 2.16 kg);
LLDPE—a linear low density polyethylene (LLDPE) having a density of 0.92 g/cc and a MFR of 200 g/10 min (at 190° C., 2.16 kg), available from Dow Chemical Company, Midland, Mich.;
Cloisite® 20A—a quaternary amine modified nanoclay with a d-spacing of 26 Anstrom (Å), available from Southern Clay Products, Gonzales, Texas;
Aerosil® 200—a hydrophilic fumed silica without surface treatment, available from Degussa, Germany;
ATH—an aluminum trihydrate powder available from Albemarle Corporation, Baton Rouge, La., under the tradename an Martinal® OL 104 LEO; and
Irganox®1010—an antioxidant available from Ciba, Tarrytown, N.Y.

### Test Methods

d-spacing

In the following examples, the interlayer spacing or d-spacing of nanoclays was assessed by XRD using a PANalytical X'Pert MPD diffractometer. The incident wavelength used was 1.54 Å. During testing, the samples were pressed into ⅛″ plaques and scanned in 2-THETA ranges from 1 to 10 degree at a rate of 1 degree/min. Because Cloisite® 20A has a d-spacing of 26 Anstrom (Å), the examples with a d-spacing value greater than 26 Å are considered at least partially intercalated in the polymer matrix.

Combustion Performance

The minimum oxygen concentration to sustain burning (Limiting Oxygen Index, LOI) was determined according to ASTM D2863.

A UL-94 test was employed to determine the flammability of the various compositions tested. In general, during the test, the specimens were held vertically and exposed to a Bunsen burner placed near the lower edge of the specimen. The materials could then be classified into three categories, V-0, V-1, and V-2, with V-0 being the least flammable. The categories reflect the persistence of combustion after several exposures to the burner flame and whether burning drops of the thus-treated specimens ignited cotton wool.

Moisture Gain

The moisture gain of the nanocomposite compositions was determined by immersing the specimens in a water bath at 70° C. for 162 hours. The percent weight gain before and after the water immersion was reported as the moisture gain for each sample.

Melt Viscosity

The melt viscosity was determined at 190° C. using a Dynisco LCR 7001 Capillary Rheometer. The die used had dimensions of 30 mm/1 mm (L/D).

### Comparative Examples CE1-CE3 and Examples E1-E8

In each of the following examples, the blend or nanofiller masterbatch was prepared by compounding using a 30 mm twin screw extruder (Coperion Inc., Ramsey, N.J.). The polymer resin(s) were added through the rear feed throat (barrel 1) of the extruder, and then the nanofiller was fed at barrel 5 (of 9 barrels) with a side stuffer and weight loss feeder. The barrel temperatures were set at 180° C. In each of examples E1-E8, the E/MAME component was dried in a vacuum oven at 60° C. overnight prior to extrusion. Results of physical property testing are shown in Table 1.

The d-spacing of the nanofiller in the masterbatch and the MFR and melt viscosity of the masterbatch in each of the examples are reported in Table 1. As demonstrated by CE2, when 2.5 wt % of Cloisite® was blended into MAH-g-PE, the MFR of the masterbatch was reduced by about 80% (i.e., from 1.5 to 0.29 g/10 min). While in E2-4, when 2.5 wt % of Cloisite® was blended into E/MAME, the MFR of the masterbatch was reduced by less than 64%. Also, as demonstrated by CE3, when Cloisite® is blended into MAH-g-PE, a loading of 20 wt % of the Cloisite® decreased the MFR of the masterbatch to 0.04 g/10 min and increased the melt viscosity to 1.6E+4 Pa*S at 1/10 sec or 2780 Pa*S at 1/100 sec. Therefore, a loading of Cloisite® higher than 20 wt % in MAH-g-PE would result in a material that has too high a viscosity for processing. In contrast, Sample E5 having a 20 wt % load of Cloisite® in E/MAME had a MFR of 1.6 g/10 min and a melt viscosity of 5.9E+3 Pa*S at 1/10 sec or 1096 Pa*S at 1/100 sec, Sample E6 having a 40 wt % load of Cloisite® in E/MAME had a MFR of 0.07 g/10 min and a melt viscosity of 1.2E+4 Pa*S at 1/10 sec or 1950 Pa*S at 1/100 sec, and Sample E7 having a 50 wt % load of Cloisite® in E/MAME had a MFR of 0.1 g/10 min.

TABLE 1

| | | | | | | | | | | | Melt | Melt |
|---|---|---|---|---|---|---|---|---|---|---|---|---|
| | | | | | | | | | | | Viscosity | Viscosity |
| | | | | | | | | | MFR | d- | (Pa*S @ | (Pa*S @ |
| | EVA-1 | MAH-g-PE | E/MAME-1 | E/MAME-2 | E/MAME-3 | E/MAME-4 | Cloisite ® | Aerosil ® | (g/10 | spac- | 1/10 | 1/100 |
| | (wt %) | (wt %) | (wt %) | (wt %) | (wt %) | (wt %) | (wt %) | (wt %) | min) | ing | sec.) | sec.) |
| CE1 | 75 | 20 | — | — | — | — | 5 | — | 0.36 | 40 Å | — | — |
| CE2 | — | 97.2 | — | — | — | — | 2.5 | — | 0.29 | No | — | — |
| | | | | | | | | | | Peak^{a} | | |
| CE3 | — | 80 | — | — | — | — | 20 | — | 0.04 | — | 1.6E+4 | 2780 |
| E1 | 75 | — | 20 | — | — | — | 5 | — | 1.1 | 40 Å | — | — |
| E2 | — | — | 97.5 | — | — | — | 2.5 | — | 10.9 | 39 | — | — |
| E3 | — | — | — | — | 97.5 | 0 | 2.5 | — | 2.2 | 38 | — | — |
| E4 | — | — | — | — | — | 97.5 | 2.5 | — | 5.9 | 38 | — | — |
| E5 | — | — | 80 | — | — | — | 20 | — | 1.6 | — | 5.9E+3 | 1096 |
| E6 | — | — | 60 | — | — | — | 40 | — | 0.07 | 36 | 1.2E+4 | 1950 |
| E7 | — | — | — | 50 | — | — | 50 | — | 0.1 | 39 | 9.5E+3 | 1500 |
| E8 | — | — | 85 | — | — | — | — | 15 | 3.5 | — | — | — |

^{a}When no peak was detected through XRD, it is meant that the nanofiller was fully exfoliated in the polymer matrix.

### Examples E9-E12

The blend or nanocomposite in each of samples E9-E12 was prepared by the same process used to prepare E1, except that both the polymer resins and the nanofiller masterbatch were fed through the rear feed throat of the extruder.

The d-spacing of the nanofiller in the nanocomposite and the MFR of the nanocomposites is shown in Table 2.

TABLE 2

| | | | | Nanofiller | Cloisite ® Content | | |
|---|---|---|---|---|---|---|---|
| | EVA-1 | EVA-2 | LLDPE | Masterbatch | (final) | MFR | |
| | (wt %) | (wt %) | (wt %) | (wt %) | (wt %) | (g/10 min) | d-spacing |
| E9 | 75 | — | — | E5 (25) | 5 | 0.61 | 41 |
| E10 | — | 87.5 | — | E6 (12.5) | 5 | 1.3 | 38 |
| E11 | 90 | — | — | E7 (10) | 5 | 1.6 | 41 |
| E12 | — | — | 90 | E7 (10) | 5 | 0.9 | 40 |

### Comparative Example CE4-CE7 and Examples E13-16

The blend or nanocomposite in each of CE4-CE7 and E13-E16 was prepared by a process similar to that used to prepare sample E1, except that (a) the first barrel temperature of the extruder was set at a temperature of 100° C. and all the remaining temperature-controlled extruder parts, including the die, were set at a temperature of 145° C.; (b) all the polymer resins and nanofiller masterbatches were added through the rear feed throat (barrel 1) of the extruder; and (c) all the filler components, i.e., ATH, Cloisite®, and/or Irganox® were fed to the extruder at barrel 8 (of 9 barrels) with a side stuffer and weight loss feeder.

As shown in Table 3, the E14 the nanocomposite (containing 5 wt % Cloisite® and 2 wt % E/MAME-1) has higher MFR and lower moisture gain compared to that of CE4 nanocomposite (containing 5 wt % Cloisite® but no E/MAME).

As shown in Table 4, the addition of E/MAME in place of MAH-g-PE in CE7 results in the EVA/ATH composition having lower moisture gain, compared to that of CE6. In addition, in each of E15 and E16, where Cloisite® was added using the nanoclay masterbatch prepared in E6 or E7, the nanocomposite maintained comparable high LOI levels (31.2% and 35.7%, respectively), compared to that of CE6 or CE7. Further, each of E15 and E16 has better UL-94 ratings (V-0) and lower moisture gain (7.4 wt % and 8.6 wt %, respectively), compared to CE6.

TABLE 3

| | | | | | | | Cloisite ® Content | | | | Moisture |
|---|---|---|---|---|---|---|---|---|---|---|---|
| | EVA-1 | EVA-3 | MAH-g-PE | E/MAME-1 | ATH | Cloisite ® | (final) | MFR | LOI | UL-94 | Gain |
| | (wt %) | (wt %) | (wt %) | (wt %) | (wt %) | (wt %) | (wt %) | (g/10 min) | (%) | Rating | (wt %) |
| CE4 | 47.7 | 2 | — | — | 45 | 5 | 5 | 0.07 | 28.7 | V-1 | 18.7 |
| CE5 | 45.7 | — | 4 | — | 45 | 5 | 5 | 0.039 | 27.7 | V-1 | 12.8 |
| E13 | 45.7 | — | — | 4 | 45 | 5 | 5 | 0.36 | 26.5 | Failed | 10.7 |
| E14 | 47.7 | — | — | 2 | 45 | 5 | 5 | 0.4 | 27.8 | V-1 | 11.9 |

TABLE 4

| | | | | Nanofiller | | | Cloisite ® Content | | | | Moisture |
|---|---|---|---|---|---|---|---|---|---|---|---|
| | EVA-1 | MAH-g-PE | E/MAME-2 | Masterbatch | ATH | Irganox ® | (final) | MFR | LOI | UL-94 | Gain |
| | (wt %) | (wt %) | (wt %) | (wt %) | (wt %) | (wt %) | (wt %) | (g/10 min) | (%) | Rating | (wt %) |
| CE6 | 30.7 | 4 | — | — | 65 | 0.3 | 0 | 0.14 | 33.5 | V-1 | 10.1 |
| CE7 | 30.7 | — | 4 | — | 65 | 0.3 | 0 | 0.12 | 34.5 | V-1 | 3.4 |
| E15 | 32.2 | — | — | E6 (12.5) | 55 | 0.3 | 5 | 0.01 | 31.2 | V-0 | 7.4 |
| E16 | 29.7 | — | — | E7 (10) | 60 | 0.3 | 5 | 0.06 | 35.7 | V-0 | 8.6 |

What is claimed is:

1. A composition comprising (a) an ethylene/ester copolymer comprising copolymerized units of ethylene and an ester of a C₄-C₈ unsaturated acid, (b) a nanofiller, and optionally (c) a first polyolefin other than an ethylene/ester copolymer comprising copolymerized units of ethylene and an ester of a C₄-C₈ unsaturated acid, wherein (i) the ethylene/ester copolymer is produced by high-pressure random copolymerization and comprises copolymerized units of about 4 wt % to about 20 wt %, based on the total weight of the copolymer, of an ester of a C₄-C₈ unsaturated acid selected from the group consisting of monoesters of C₄-C₈ unsaturated acids having at least two carboxylic acid groups, diesters of C₄-C₈ unsaturated acids having at least two carboxylic acid groups, and mixtures of two or more thereof and (ii) the first polyolefin is selected from the group consisting of ethylene polymers, propylene polymers and blends of two or more thereof.

2. The composition of claim 1, wherein the first component (a) ethylene/ester copolymer is present at a level of about 10 to about 95 wt %, based on the total weight of the composition and the second component (b) nanofiller is present at a level of about 0.5 to about 70 wt %, based on the total weight of the composition.

3. The composition of claim 2, wherein the first component (a) ethylene/ester copolymer is present at a level of about 30 to about 90 wt %, based on the total weight of the composition.

4. The composition of claim 2, wherein the second component (b) nanofiller is present at a level of about 20 to about 70 wt %, based on the total weight of the composition.

5. The composition of claim 1, wherein the ethylene/ester copolymer further comprises up to about 10 wt %, based on the total weight of the ethylene/ester copolymer, of copolymerized units of a third comonomer selected from the group consisting of vinyl acetate, acrylic acid, methacrylic acid, derivatives of acrylic acid, and derivatives of methacrylic acid.

6. The composition of claim 5 wherein the derivative of acrylic acid is an alkyl acrylate.

7. The composition of claim 5 wherein the derivative of methacrylic acid is an alkyl methacrylate.

8. The composition of claim 1, wherein the ester of a C₄-C₈ unsaturated acid is a monoester of a C₄-C₈ unsaturated acid having at least two carboxylic acid groups.

9. The composition of claim 8, wherein the monoester is ethyl hydrogen maleate.

10. The composition of claim 1, wherein the ethylene/ester copolymer is selected from the group consisting of ethylene/maleic acid monoester dipolymers, ethylene/maleic acid monoester/n-butyl acrylate terpolymers, ethylene/maleic acid monoester/n-butyl methacrylate terpolymers, ethylene/maleic acid monoester/methyl acrylate terpolymers, ethylene/maleic acid monoester/methyl methacrylate terpolymers, ethylene/maleic acid monoester/ethyl acrylate terpolymers and ethylene/maleic acid monoester/ethyl methacrylate terpolymers.

11. The composition of claim 1, wherein the nanofiller has a particle size of about 0.9 to about 200 nm and is selected from the group consisting of nano-sized silicas, nanoclays, and carbon nanofibers.

12. The composition of claim 11, wherein the nanofiller is a nano-sized silica selected from the group consisting of fumed silica, colloidal silica, fused silica, silicate, and mixtures of two or more thereof.

13. The composition of claim 11, wherein the nanofiller is a nanoclay selected from the group consisting of smectite, hectorites, montmorillonite, bentonite, beidelite, saponite, stevensite, sauconite, nontronite, illite, and mixtures of two or more thereof.

14. The composition of claim 1, wherein the optional third component (c) first polyolefin is present at a level of up to about 80 wt %, based on the total weight of the composition.

15. The composition of claim 1, further comprising (d) a polymer at a level of about 50 to about 90 wt %, based on the total weight of the composition.

16. The composition of claim 15, wherein the component (d) polymer is selected from the group consisting of polyolefins, polyamides, polyesters, polycarbonates, polystyrenes, poly(acrylonitrile-co-butadine-co-styrene), and thermoplastic polyurethane.

17. The composition of claim 16, wherein the component (d) polymer is a second polyolefin that is other than an ethylene/ester copolymer comprising copolymerized units of ethylene and an ester of a C₄-C₈ unsaturated acid and is selected from the group consisting of ethylene polymers, propylene polymers and blends of two or more thereof.

18. A shaped article comprising the composition recited in claim 1.

19. A shaped article comprising the composition recited in claim 15.

20. The shaped article of claim 19, wherein the shaped article is selected from the group consisting of sheets, films, panels, and wire or cable coatings.

21. The shaped article of claim 20, wherein the shaped article is a wire or cable coating, and wherein the composition recited in claim 15 further comprises a flame retardant.

22. A process for preparing a homogeneous nanofiller masterbatch composition comprising the steps of:
(A) forming a mixture comprising (i) an ethylene/ester copolymer comprising copolymerized units of ethylene and an ester of a C₄-C₈ unsaturated acid, (ii) a nanofiller, and optionally (iii) a first polyolefin other than an ethylene/ester copolymer comprising copolymerized units of ethylene and an ester of a C₄-C₈ unsaturated acid, wherein the ethylene/ester copolymer is produced by high-pressure random copolymerization and comprises copolymerized units of about 4 to about 20 wt %, based on the total weight of the copolymer, of an ester of a C₄-C₈ unsaturated acid selected from the group consisting of monoesters of C₄-C₈ unsaturated acids having at least two carboxylic acid groups, diesters of C₄-C₈ unsaturated acids having at least two carboxylic acid groups, and mixtures of two or more thereof, and wherein the first polyolefin is selected from the group consisting of ethylene polymers, propylene polymers and blends of two or more thereof;
(B) melt compounding the mixture to form the homogeneous nanofiller masterbatch composition; and
(C) recovering the homogeneous nanofiller masterbatch composition.

23. The process of claim 22, wherein the nanofiller is present in the mixture at a level of about 20 to about 70 wt %, based on the total weight of the mixture.

24. A process for preparing a homogeneous nanocomposite composition comprising the steps of:
(A) forming a mixture comprising (i) the nanofiller masterbatch composition obtained by the process of claim 22 and (ii) a polymer selected from a polyamide or a second polyolefin, wherein the second polyolefin is other than an ethylene/ester copolymer comprising copolymerized units of ethylene and an ester of a C₄-C₈ unsaturated acid and is selected from the group consisting of ethylene polymers, propylene polymers and blends thereof;
(B) melt compounding the mixture to form the homogeneous nanocomposite composition; and
(C) recovering the homogeneous nanocomposite composition.
